(19) United States
(12) Patent Application Publication
(10) Pub. No.: US 2021/0316800 A1
(43) Pub. Date: Oct. 14, 2021

(54) TRACK FOR A TRACKED VEHICLE IN PARTICULAR FOR PREPARING SKI PISTES, AND THE TRACKED VEHICLE COMPRISING A PLURALITY OF SAID TRACKS

(71) Applicant: PRINOTH S.P.A., Vipiteno (IT)

(72) Inventors: Markus Straninger, Vomp (AT); Martin Kirchmair, Vipiteno (IT); Gregor Maurer, Vipiteno (IT)

(21) Appl. No.: 17/272,857

(22) PCT Filed: Sep. 3, 2019
(86) PCT No.: PCT/IB2019/057422

§ 371 Date: Mar. 2, 2021

(30) Foreign Application Priority Data
Sep. 10, 2018 (IT) 102018000008467

(51) Int. Cl. B62D 55/088; B62D 55/253; B62D 55/28

(52) U.S. Cl. CPC B62D 55/088; B62D 55/286; B62D 55/253

(57) ABSTRACT

Track for a tracked vehicle comprising an outside face, which, in use, is in contact with the ground while the tracked vehicle moves forward; an internal face on the back side of the outside face and which, in use, is not in contact with the ground; a first lateral end which, in use, is faced to the outside of the tracked vehicle; a second lateral end which, in use, is faced to the inner side of the tracked vehicle; wherein the track comprises: at least a first belt which is configured to be wound on a rear wheel and a front wheel and extending to a forward direction; a plurality of crosslinks transverse to the forward direction connected to at least the first belt and along the outside face of the track; a guide assembly connected along the inner face of the track and configured to define a seat assembly for the front wheel and the rear wheel; and cutting devices fixed along the inner face of the track and wherein the distance between the cutting device and the first end is smaller than the distance between the guide assembly and the first end.

### CROSS-REFERENCE TO RELATED APPLICATIONS

This Patent Application claims priority from Italian Patent Application No. 102018000008467 filed on Sep. 10, 2018, the entire disclosure of which is incorporated herein by reference.

### TECHNICAL FIELD

The present invention concerns a track for a tracked vehicle, in particular for the preparation of ski pistes, and the tracked vehicle comprising a plurality of said tracks.

### BACKGROUND ART

Generally, a tracked vehicle for the preparation of ski pistes comprises two rear wheels driven by an engine; two front wheels; at least two support wheels placed between the rear wheels and the front wheels; and two tracks, each of which is wound in a ring between a respective front wheel and a respective rear wheel. Each track comprises an inner face and an outside face which, in use, is arranged in contact with the ground. In addition, the tracked vehicle for the preparation of ski pistes is equipped with a snow cutter that is mounted behind it and that is configured for grooming snow and creating a ski piste.

One drawback of the prior art is that in use, blocks of snow and/or ice can accumulate inside the track between the inner face of the track and around the support wheels and/or the front wheels and/or the rear wheels. These blocks of snow and/or ice can escape the track to the side of the tracked vehicle in an uncontrolled manner and ruin the preparation of the ski piste because said blocks are not captured and processed by the snow cutter. This can result in an imperfect finish of the snow and/or in additional preparation time and costs for a ski piste, because the operator has to go over the freshly groomed snow to avoid leaving blocks of snow and/or ice on the ski piste.

### DISCLOSURE OF INVENTION

The purpose of the present invention is a track for a tracked vehicle in particular for the preparation of ski pistes that reduces the drawbacks of the known art.

According to the present invention, a track is made for a tracked vehicle, in particular for the preparation of ski pistes; the track being configured to be wound around one respective rear wheel and one front wheel of the tracked vehicle; the track comprising an outside face which, in use, is in contact with the ground while the tracked vehicle moves forward; one inner face on the back side of the outside face and which, in use, is not in contact with the ground; one first lateral end that, in use, is faced to the outside of the tracked vehicle; a second lateral end that, in use, is faced to the inner side of the tracked vehicle; at least one first belt configured to be wound around the rear wheel and the front wheel and extending in the tracked vehicle's forward direction; a plurality of crosslinks transverse to the forward direction connected to at least the first belt and along the outside face of the track, the crosslinks preferably being metal; a guide assembly connected along the inner face of the track and configured to define a seat assembly for the front wheel and the rear wheel; and cutting devices connected along the inner face of the track and positioned closer to the first lateral end than the guide assembly.

Thanks to the present invention, large blocks of snow or ice escaping from the side of the tracks are avoided, in fact the cutters keep the large blocks of ice inside the track or crumble them into small blocks of ice that can be treated by the cutter or even left on the ski piste, as they do not have a great impact on the overall quality of the finish of the ski piste.

According to a preferred embodiment of the present invention, the track comprises a plurality of belts, preferably of at least partly elastomeric material, comprising at least the first belt and that extend in the forward direction and wherein the crosslinks are connected to the plurality of belts.

According to another preferred embodiment, the guide assembly comprises a plurality of guide elements connected along the inner face of the track, preferably each guide element is connected to a respective crosslink of the plurality of crosslinks along the inner face of the track.

According to another preferred embodiment, the crosslinks are connected to at least one belt through fixing means, in particular through plates and bolts.

According to another preferred embodiment, each cutting device is connected along the inner face of the track and comprises a first end connected to a belt of the plurality of belts and a second end connected to another belt of the plurality of belts preferably through at least part of the fixing means that connect the belts to the crosslinks.

According to another preferred embodiment, each cutting device is connected along the inner face of the track and in particular in contact with one of the belts of the plurality of belts and comprises a first end connected to the said belt and a second end connected to the said belt, preferably through at least part of the fixing means.

According to another preferred embodiment, each cutting device is connected along the inner face of the track and in particular is connected to the cross bar along an inner face of the cross bar; the inner face of the cross bar is on the back side of the face of the cross bar that is in contact with the ground; in particular the cutting device being directly connected to the cross bar through fixing elements.

According to another preferred embodiment, each cutting device comprises a base connected to the inner face of the track and a cutter connected to the base.

According to another preferred embodiment, the cutter is connected to the base through a hinge so that the cutter can rotate around an axis between a rest position and a work position, wherein, in use, the cutter is configured to cut blocks of ice or snow.

According to another preferred embodiment, the base comprises a stop that abuts against the cutter in the work position.

According to another preferred embodiment, the cutter comprises a main body able to cut and two wings that extend on a plane perpendicular to the plane on which the main body extends.

According to another preferred embodiment, the cutter is formed from a single piece, in particular from a folded metal sheet so that the main body is formed from two layers of the metal sheet and the wings are formed from a single layer of the metal sheet.

According to another preferred embodiment, the base is connected at one end to one belt of the plurality of belts and at another end to another belt of the plurality of belts.

According to another preferred embodiment, the cutter comprises a main body able to cut and two wings that extend on a plane perpendicular to the plane on which the main body extends, and in which the stop abuts against the wings of the cutter when the cutter is in the work position.

According to another preferred embodiment, the hinge that connects the base to the cutter has a rotation axis, which is transversal, in particular perpendicular, to the forward direction.

Another purpose of the present invention is to create a tracked vehicle, in particular for the preparation of ski pistes that reduces at least one of the drawbacks of the known art.

According to the present invention a tracked vehicle is made, in particular for the preparation of ski pistes; the tracked vehicle comprising: a frame; two rear wheels supported by the frame; two front wheels supported by the frame; a plurality of tracks, preferably two, each of which as claimed in any of the claims from 1 to 12; and in which each track is wound around one respective rear wheel and one respective front wheel.

According to a preferred embodiment, in which the tracked vehicle comprises two pluralities of support wheels; each plurality of support wheels is arranged between one of the respective front wheels and one of the respective rear wheels; each track being wound around one of the respective front wheels, one of the respective plurality of support wheels, and one of the respective rear wheels.

According to a preferred embodiment, the guide assemblies of each track are in contact with the support wheels.

### BRIEF DESCRIPTION OF THE DRAWINGS

Further characteristics and advantages of the present invention will become clear from the following description of its non-limiting examples of embodiments, with reference to the accompanying figures, wherein:

FIG. 1 is a lateral elevation view, with some parts removed for clarity, of a tracked vehicle configured for the preparation of ski pistes provided with tracks in accordance with the present invention;

FIG. 2 is an upper elevation view of the tracked vehicle, and of the tracks of FIG. 1, with some parts removed for clarity;

FIG. 3 is an enlarged perspective elevation view of one of the tracks of FIG. 1, with some parts removed for clarity;

FIG. 4 is a cross-sectional view of FIG. 3, with some parts removed for clarity and on an enlarged scale;

FIG. 5 is a perspective view of a cutting device in a work position and made according to the present invention;

FIG. 6 is a perspective view of the cutting device of FIG. 5 but in a rest position and made according to the present invention;

FIG. 7 is an enlarged perspective elevation view of an alternative embodiment of the present invention, with some parts removed for clarity; and

FIG. 8 is an enlarged perspective elevation view of an alternative embodiment of the present invention, with some parts removed for clarity.

### BEST MODE FOR CARRYING OUT THE INVENTION

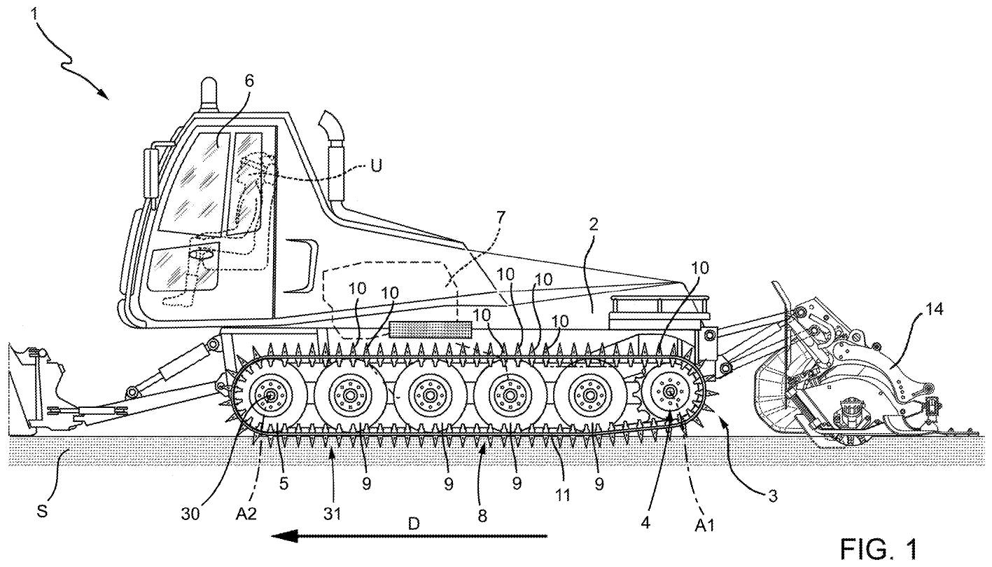

With reference to FIG. 1, a tracked vehicle for the preparation of ski pistes, in particular a snow groomer, is designated as a whole by the number 1.

The tracked vehicle 1 comprises a frame 2; two tracks (only one of which is illustrated in FIG. 1); two rear wheels 4 (only one of which is illustrated in FIG. 1) rotatable about a rotation axis A1; two front wheels 5 (only one of which is illustrated in FIG. 1) rotatable about a rotation axis A2 that is parallel to the axis A1; a cab 6; and an engine 7. The rear wheels 4 are drive wheels driven independently of one another by actuators, preferably of the hydraulic or electric or mechanical type, and are coupled to the respective tracks 3.

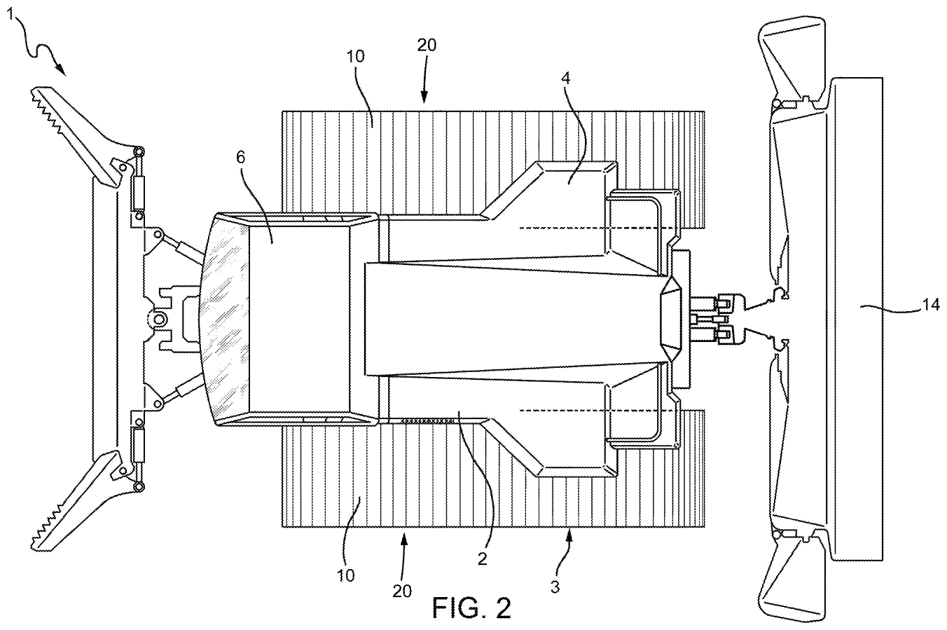

With reference to FIGS. 1 and 2, the tracked vehicle 1 comprises a snow cutter 14 positioned at the rear of the tracked vehicle 1 and that extends laterally across a greater dimension than the lateral dimension of the tracked vehicle 1 and of the tracks 3.

Each track 3 is wound in a ring between one of the respective two rear wheels 4 and one of the respective two front wheels 5. In other words, the rear wheel 4 and the front wheel 5 engage the track 3, along an inner face 30 of the track 3. The inner face 30, in use, is not in contact with the ground S. Each track 3 has an outside face 31 which is on the back side of the inner face 30 and which, in use, is in contact with the ground S while the tracked vehicle 1 moves forward.

The tracked vehicle 1 comprises two pluralities of support wheels 9, in particular a plurality for each track 3. In other words, each track 3 cooperates with the support wheels 9 arranged in sequence between the front wheel 5 and the rear wheel 4. The support wheels 9 are arranged inside the ring of the respective track 3 between the respective rear wheel 4 and the respective front wheel 5 to distribute the mass of the tracked vehicle 1 along the traction portion 8 of the track 3, and to compress a traction portion 8 of the track 3 itself against the ground S in order to achieve greater adherence to the ground S and to reduce any slipping of the track 3 on the ground S. The support wheels 9 are in contact with the inner face 30 of the respective track 3.

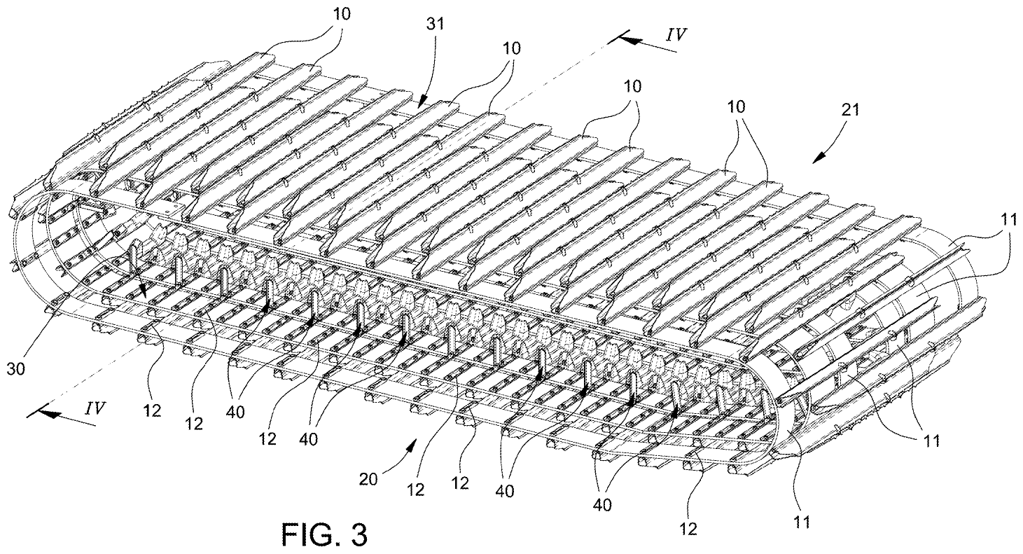

With reference to FIGS. 1 and 3, each track 3 comprises a plurality of crosslinks 10 arranged transversely to the forward direction D and a plurality of belts 11 made of an elastomeric material, in particular rubber, to which the crosslinks 10 are fixed spaced apart from each other along the forward direction D. In one embodiment the belts comprise composite elastomeric material, for example, with internal fibres.

Each crosslink 10 comprises a crampon and is clamped to the belts 11 through fixing means 12, in particular metal plates and bolts. Thus, the crosslinks 10 also have the function of keeping the belts 11 spaced apart from each other. With reference to FIGS. 1, 2 and 3, the belts 11 are wound in a ring and arranged side-by-side along an axis parallel to the axis A1 or A2 and extend along a direction parallel to the forward direction D. In a preferred embodiment, each track 3 comprises a number of belts 11 varying between two and eight. In another embodiment, each belt 11 is composed of portions of belt which joined together form the belt 11 wound in a ring.

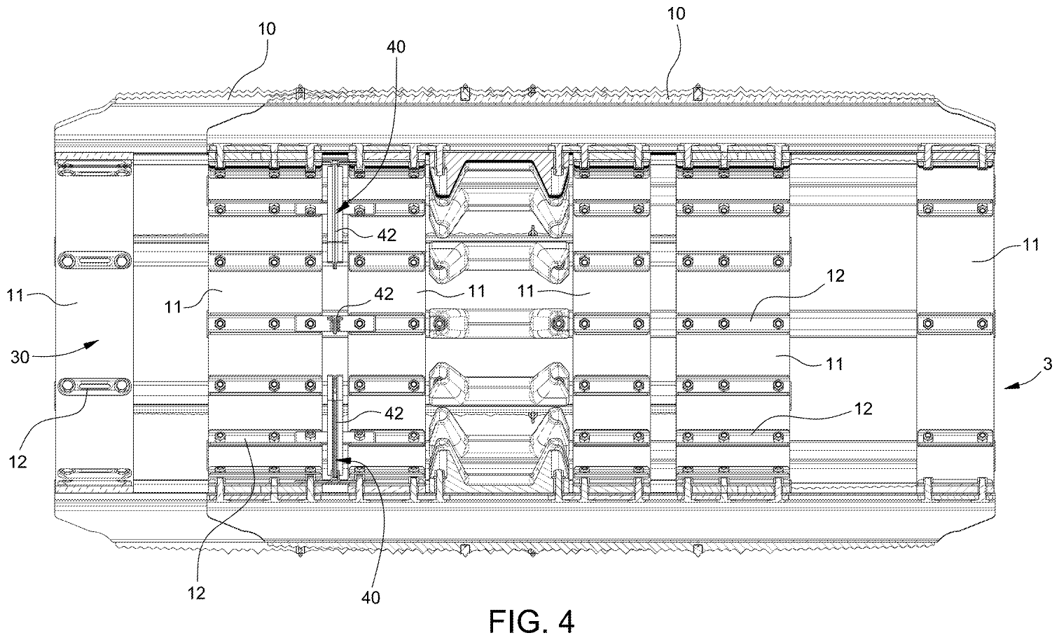

With reference to FIGS. 1 and 4, each track 3 comprises guides 13 which are arranged along the inner face 30 of the track 3. The set of guides 13 of each track 3 defines a guide assembly. Each guide 13 is clamped to one of the respective crosslinks 10. The guides 13 define the coupling seats with the support wheels 9 and with the front wheels 5 and the rear wheels 4. In particular the guides 13 are configured to keep the support wheels 9 in the correct position inside the respective track 3.

The support wheels 9 are arranged inside the ring of the track 3 and each has a rotation axis parallel to the rotation axis A1 of the rear wheel 4.

In a particular, non-limiting embodiment of the present invention, not illustrated in the attached figures, the plurality of wheels are mounted in pairs on a respective structure. In more detail, the structure is a rocker arm that houses one support wheel of the pair of support wheels at its opposite ends. The structure in turn is connected by a rotating connection to the frame of the tracked vehicle.

In addition, with reference to FIGS. 2 to 4, each track 3 comprises a lateral end 20 which, in use, is faced to the outside of the tracked vehicle 1; and a lateral end 21 which, in use, is faced to the inner side of the tracked vehicle 1; and a plurality of cutting devices 40 connected along the inner face 30 of the track 3 and positioned closer to the lateral end 20 than the guides 12.

With reference to FIG. 4, each cutting device 40 is connected along the inner face 30 of the track 3 between two belts 11 through part of the fastening means 12 that connect the belts 11 to the crosslinks 10.

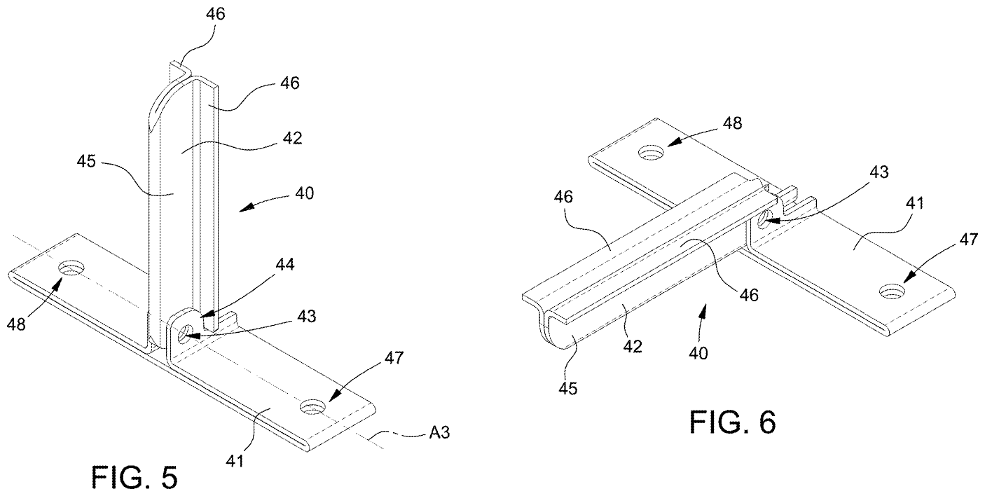

With reference to FIGS. 4, 5 and 6, each cutting device 40 comprises a base 41 connected to the inner face 30 of the track 3, and a cutter 42 connected to the base 41 through a hinge 43 so that the cutter 42 can rotate around an axis A3 between a work position PL as illustrated in FIG. 5, and a rest position PR as illustrated in FIG. 6. In more detail, in the work position PL, the cutter 42 is positioned perpendicularly to the forward direction D and extends from the base 41 and from the track 3 perpendicularly to them. In the rest position PR, the cutter 42 is positioned parallel to the forward direction D, so that the track 3, when not connected to the tracked vehicle 1, can be easily rolled up for transport or storage.

In addition, with reference to FIG. 5, the base 41 of the cutting device 40 comprises a stop 44, which abuts against the cutter 42 in the work position PL. In addition, the cutter 42 comprises a main body 45 able to cut and two wings 46 extending on a plane perpendicular to the plane on which the main body 45 lies. The cutter 42 is formed from a single piece, in particular a folded metal sheet, so that the main body 45 is formed from two layers of the metal sheet and the wings 46 are formed from a single layer of the metal sheet.

In an alternative embodiment of the invention, the cutting device 40, in particular the base 41 and the cutter 42, is produced through forging or fusion.

With reference to FIG. 5, the stop 44 abuts against the wings 46 of the cutter 42 when the cutter 42 is in the work position PL.

With reference to FIG. 4, the base 41 comprises one end 47 connected to one of the belts 11 and another end 48 connected to another of the belts 11 through the metal plates 12, which connect the belts 11 to the crosslinks 10.

In an alternative embodiment, not illustrated in the attached figures, the base is connected, preferably directly, to one of the crosslinks. In other words, in this embodiment, each cutting device is connected along the inner face of the track and in particular is connected to a respective crosslink of the plurality of crosslinks along an inner face of the cross bar. In more detail, the cutting device is directly connected to the crosslink 10 through fixing elements.

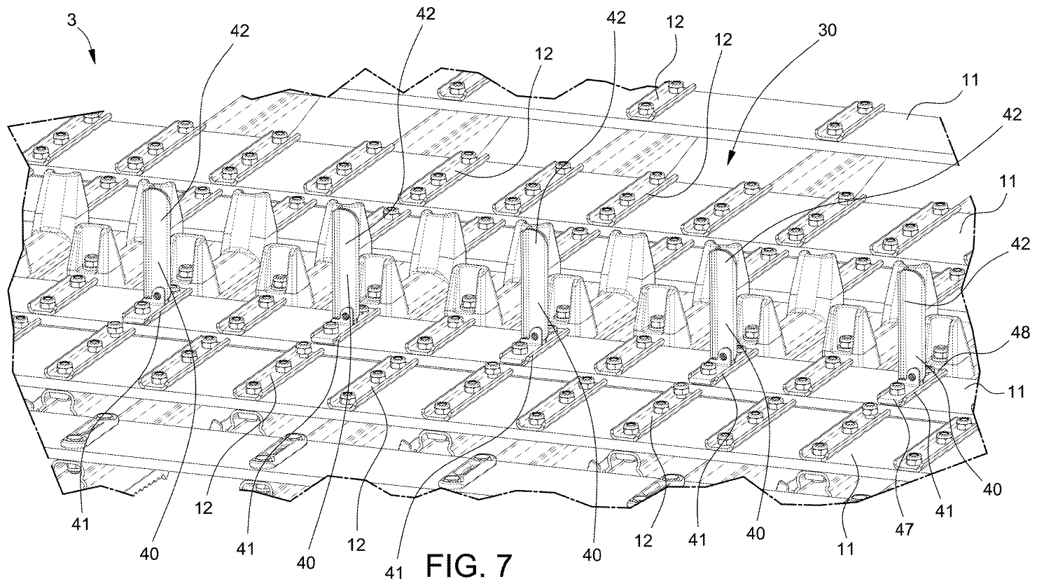

In another embodiment illustrated in FIG. 7, each cutting device 40 is connected along the inner face 30 of the track 3 and in particular in contact with one of the belts 11 of the plurality of belts 11 and comprises one end 47 connected to said belt 11 and another end 48 connected to the same said belt 11 through part of the fixing means 12, in particular the bolts. In particular, in this embodiment, the entire base 41 of the cutting device 40 is connected to said belt 11, and in particular to a single said belt 11.

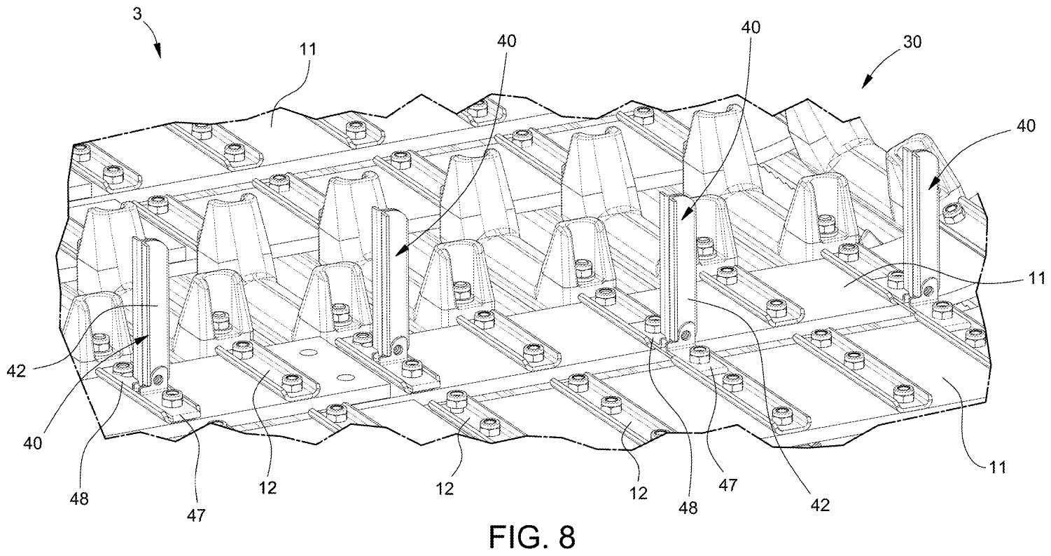

In another embodiment of the present invention illustrated here, the different ways of connecting the cutting devices inside the track, as described above, can be combined with each other. For example, FIG. 8 illustrates one embodiment wherein some cutting devices 40 are connected to a single belt 11 and other cutting devices 40 are connected between two belts 11. Another embodiment of the present invention requires that some cutting devices are connected between two belts and others directly to the cross bar from the inner side of the track. Another embodiment of the present invention requires that some cutting devices are connected to a single belt and others to the cross bar from the inner side of the track. Another embodiment of the present invention requires that some cutting devices are connected between two belts, other cutting devices are connected to the cross bar on the inner side of the track and other cutting devices still are connected to a single belt.

In addition, with reference to FIGS. 4, 5 and 6, in the work position PL the hinge 43, which connects the base 41 and the cutter 42, having the rotation axis A3, which is transversal, in particular perpendicular, to the forward direction D prevents the blocks of snow or ice from escaping externally from the tracked vehicle 1, or cuts these blocks of snow or ice into smaller pieces that do not significantly affect the snow and/or its grooming.

Finally, in a preferred embodiment not illustrated in the attached figures, the cutting devices can be held in the work position PL or in the rest position PR through a locking element or through a spring element, in particular a load spring.

The scope of protection of the present invention is defined by the claims which cover variants not specifically described and equivalent embodiments.

The invention claimed is:

1-17. (canceled)

18. A track comprising:
an outside face configured to contact a ground surface;
an inner face on a back side of the outside face;
a first belt extending in a first direction, the first belt configured to be wound on a rear wheel of a tracked vehicle and a front wheel of the tracked vehicle;
a first lateral end configured to face an outer side of the tracked vehicle when the first belt is wound on the rear wheel of the tracked vehicle and the front wheel of the tracked vehicle;
a second lateral end configured to face an inner side of the tracked vehicle when the first belt is wound on the rear wheel of the tracked vehicle and the front wheel of the tracked vehicle;
a plurality of crosslinks transversal to the first direction and connected to the first belt along the outside face;
a guide assembly connected along the inner face and defining a seat assembly for the front wheel and the rear wheel; and
a plurality of cutting devices fixed along the inner face, wherein for each cutting device, a distance between that cutting device and the first lateral end is smaller than a distance between the guide assembly and the first lateral end.

19. The track of claim 18, leather comprising a plurality of belts which include the first belt, wherein the plurality of belts excluding the first belt each extend in parallel to the first belt and the plurality of crosslinks are connected to the plurality of belts.

20. The track of claim 19, wherein each cutting device is connected along the inner face and comprises a first end connected to one belt of the plurality of belts and a second end connected to another belt of the plurality of belts.

21. The track of claim 19, wherein each cutting device is connected along the inner face and comprises a first end connected to one belt of the plurality of belts and a second end connected to the same one belt of the plurality of belts.

22. The track of claim 19, wherein each cutting device is connected along the inner face to one of the crosslinks of the plurality of crosslinks along an inner face of the crosslink opposed to a face of the crosslink configured to contact the ground surface.

23. The track of claim 18, wherein each cutting device comprises a base connected to the inner face and a cutter connected to the base.

24. The track of claim 23, wherein the cutter comprises a main body configured to cut, two wings extending in a plane perpendicular to the plane in which the main body lies, and a stop configured to stop the two wings when the cutter is in a work position.

25. The track of claim 23, wherein the cutter is connected to the base through a hinge such that the cutter is rotatable around an axis from a rest position to a work position in which the cutter is configured to cut at least one of snow and an ice block.

26. The track of claim 25, wherein the hinge connecting the base to the cutter has a rotation axis which is transversal to the first direction.

27. The track of claim 23, wherein the cutter comprises a main body configured to cut and two wings extending in a plane perpendicular to a plane in which the main body lies.

28. The track of claim 27, wherein the cutter comprises a single folded metal sheet such that the main body is formed by two layers of the metal sheet and the wings are formed by a single layer of the metal sheet.

29. The track of claim 23, wherein the base comprises a stop configured to stop the cutter when the cutter is in a work position.

30. The track of claim 18, wherein the guide assembly comprises a plurality of guide elements connected along the inner face, each guide element being connected to one of the crosslinks of the plurality of crosslinks along the inner face.

31. A tracked vehicle comprising:
a frame:
two rear wheels supported by the frame;
two front wheels supported by the frame;
a first track comprising:
a first track outside face configured to contact a ground surface;
a first track inner lace on a back side of the first track outside face;
a first track belt extending in a first direction and wound on a first one of the rear wheels and a first one of the front wheels;
a first track first lateral end facing a first outer side of the tracked vehicle;
a first track second lateral end facing a first inner side of the tracked vehicle;
a first track plurality of crosslinks transversal to the first direction and connected to the first track belt along the first track outside face;
a first track guide assembly connected along the first track inner face and defining a first seat assembly for the first one of the front wheels and the first one of the rear wheels; and
a first track plurality of cutting devices fixed along the first track inner face, wherein for each cutting device, a distance between that cutting device and the first track first lateral end is smaller than a distance between the first track guide assembly and the first track first lateral end; and
a second track comprising:
a second track outside face configured to contact the ground surface;
a second, track inner face on a back side of the second track outside face;
a second track belt extending in the first direction and wound on a second one of the rear wheels and a second one of the front wheels;
a second track first lateral end facing a second outer side of the tracked vehicle;
a second track second lateral end facing a second inner side of the tracked vehicle;
a second track plurality of crosslinks transversal to the first direction and connected to the second track belt along the second track outside face;
a second track guide assembly connected along the second track inner face and defining a second seat assembly for the second one of the front wheels and the second one of the rear wheels; and
a second track plurality of cutting devices fixed along the second track inner face, wherein for each cutting device, a distance between that cutting device and the second track first lateral end is smaller than a distance between the second track guide assembly and the second track first lateral end.

32. The tracked vehicle of claim 31, further comprising:
a first plurality of support wheels arranged between the first one of the front wheels and the first one of the rear wheels, wherein the first track is wound to the first plurality of support wheels, the first one of the front wheels and the first one of the rear wheels, and
a second plurality of support wheels arranged between the second one of the front wheels and the second one of the rear wheels, wherein the second track is wound to the second plurality of support wheels, the second one of the front wheels and the second one of the rear wheels.

33. The tracked vehicle of claim 32, wherein the first track guide assembly of the first track is in contact with the first plurality of support wheels and the second track guide assembly of the second track is in contact with the second plurality of support wheels.
